(19) United States
(12) Patent Application Publication
(10) Pub. No.: US 2014/0013952 A1
(43) Pub. Date: Jan. 16, 2014

(54) FILTER GROUP FOR FLUIDS

(71) Applicant: Giorgio Girondi, Mantova (IT)

(72) Inventor: Giorgio Girondi, Mantova (IT)

(73) Assignee: UFI INNOVATION CENTER S.R.L., ALA (TN) (IT)

(21) Appl. No.: 14/007,460

(22) PCT Filed: Mar. 6, 2012
(86) PCT No.: PCT/IB12/00436

§ 371 Date: Sep. 25, 2013

(30) Foreign Application Priority Data
Mar. 25, 2011 (IT) RE2011A000017

(51) Int. Cl. B01D 53/22

(52) U.S. Cl. CPC B01D 53/22
USPC 96/9

(57) ABSTRACT

A filter group (40) for fluids, comprising an external casing (19) having any section, suitable for receiving at least a filter membrane (16, 18) which develops parallel to the axis of the casing (19), for dividing an internal volume of the casing (19) into two chambers (28, 29), of which a first chamber (28) is in communication with an inlet conduit (12) for the fluid to be filtered and a second chamber (29) is in communication with an outlet conduit (14) of the filtered fluid. At least a pressure distributor element (45, 46) is provided for each of the filter membranes and is accommodated in the first chamber (28), which at least a pressure distributor (45, 46) axially separates the volume of the first chamber (28) into at least two parts, the pressure distributor element being made of a material that is permeable to the flow of fluid to be filtered, wherein the pressure distributor (45, 46) for each of the filter membranes is located in an intermediate position on the respective membrane and is configured to increase the pressure differential on the upstream parts of the filter elements (16, 18).

### TECHNICAL FIELD

The present invention relates to a filter group for fluids.

In particular, the group can be used for filtering fluids such as air or gas in a broad variety of applications, among which applications in the sector of automobiles.

### BACKGROUND ART

In the filtration of comburent air in internal combustion engines, it is a common practice to include a filter group comprising a casing divided into two by a filter membrane located perpendicularly to the main direction of the flow. In these systems the pressure drop generated through the filter membrane is more or less constant over the whole surface thereof, in accordance with the choice of geometry of the container casing.

On the other hand, in the use of tangential filters, i.e. filters having a filter surface located parallel to the flow, the pressure differential along the length of the filter element is not constant.

In tangential filters a generally cylindrical casing is divided into two by a plate that is perpendicular to the axis and located in proximity of the outlet conduit, from which at least a cylindrical filter derives, with an axis parallel to the axis of the casing, which receives the flow tangentially on an external surface thereof, and discharges it through the plate after it has crossed the membrane of the filter element.

Since in automobile applications the flow crossing the fitter group is aspirated through the outlet conduit of the casing, the depression created internally of the filter element tends to diminish along the axis of the element as the flow gradually crosses the membrane of the element, i.e. towards the end proximal to the flow inlet conduit.

This means that the parts of the filter element close to the inlet conduit are not greatly used as the pressure difference created across this zone of the filter membrane is at times insufficient to enable the air to cross them.

In general this means that in known tangential filters only the downstream part of the filter membrane is interested by the filtration.

In more detail, FIG. 1 illustrates an axial filter for fluids of the known type described above, where the filter 10 comprises a casing 19 having a substantially tubular shape and being provided with an inlet conduit 12 of the fluid to be filtered and an outlet conduit 14 of the filtered fluid coaxial thereto, the casing being provided, internally thereof, with tubular filter membranes 16, 18 located in parallel, which develop in a longitudinal direction of the casing 19 and divide the internal volume into two chambers 28, 29, of which a first chamber 28 is in communication with the inlet conduit 12 for the fluid to be filtered and a second chamber 29 is in communication with the outlet conduit 14 for the filtered fluid.

A perforated (perforations 21, 23) plate 17 is comprised internally of the casing 19 on which the tubular filter membranes 16, 18 are located, all such as to define volumes 20, 22, 24 which enable fluid passage through the membrane 16, 18.

In this known configuration, the tubular filter membranes 16, 18 are poorly used at the zones that are proximal to the inlet conduit 12, while the filtration is prevalently carried out in the zones 34, 36 of the membranes 16, 18 close to the outlet conduit 14.

These zones are therefore subject to a more rapid clogging.

### DISCLOSURE OF THE INVENTION

An aim of the present invention is to provide an axial filter which enables optimal sharing-out of the loss loads, thus increasing the working life and performance of the filter.

A further aim of the invention is to attain the above-mentioned result in a way which is practical and economical.

The aims are attained by a filter group for fluids, comprising an external casing having any section, suitable for receiving at least a filter membrane which develops parallel to the axis of the casing, for dividing an internal volume of the casing into two, chambers, of which a first chamber is in communication with an inlet conduit for the fluid to be filtered and a second chamber is in communication with an outlet conduit of the filtered fluid, wherein at least a pressure distributor for each of the filter membranes is accommodated in the first chamber, which at least a pressure distributor element is suitable for axially separating a volume of the first chamber into at least two parts, the pressure distributor element being made of a material that is permeable to the flow of fluid to be filtered, characterized in that the pressure distributor for each of the filter membranes is located in an intermediate position on the respective membrane and is configured to increase the pressure differential on the upstream parts of the filter elements. An advantage of this embodiment of the invention is that it enables a sharing-out of the passage of the fluid to be filtered such as to involve the whole surface of the filter element uniformly.

In more detail, it enables the pressure differential to be shared out homogeneously along the surface of the tubular filter membrane.

In a preferred embodiment of the invention, with a single filter membrane, the pressure distribution unit has an annular shape and is located such as to envelope a part of the filter membrane, closing totally or almost totally the space between the external surface of the membrane and the external casing.

This embodiment has the advantage of providing a simple mounting of the pressure distributor on the surface of the filter membrane.

In a case in which there are at least two filter membranes, each of them will be provided with at least a pressure distributor having a perforation for accommodating the filter membrane and an external profile which is complementary to that of the other pressure distributors and the casing.

In a preferred aspect of the invention, the external surface of the pressure distributor is distanced from the internal surface of the tubular casing such as to define passages for the fluid.

This embodiment has the advantage of causing a slowing-down of the passage of the flow of fluid to be filtered, while enabling direct passage of a quantity of fluid to the lower part of the filter membrane, with the aim of graduating the distribution of the pressure differential over the whole surface of the filter membrane.

In a further aspect of the present invention, the pressure distributor element is flat and is arranged perpendicular to the longitudinal development of the casing.

An advantage of this embodiment is that the distributor element performs its action more effectively, as it is arranged perpendicular to the flow direction of the fluid to be filtered upstream of the filter membrane.

In a further aspect of the present invention, the pressure distributor is constituted by a porous element having greater permeability than that of the filter membrane.

An advantage of this embodiment is that the permeability of the porous element can be selected such as to obtain an optimal sharing-out of the flow of fluid to be filtered in part on the surface upstream of the filter membrane and in part on the downstream surface thereof, according to the geometry of the casing and the filter membrane.

### BRIEF DESCRIPTION OF THE DRAWINGS

Further characteristics and advantages of the invention will emerge from a reading of the following description, provided by way of non-limiting example, with the aid of the figures illustrated in the accompanying figures of the drawings, in which:

FIG. 1 is a section view of an axial filter according to the prior art;

FIG. 2 is a section view of an axial filter according to a first embodiment of the invention;

FIG. 3 is a section view of an axial filter of a further embodiment of the invention; and

FIG. 4 is section IV-IV of FIG. 3.

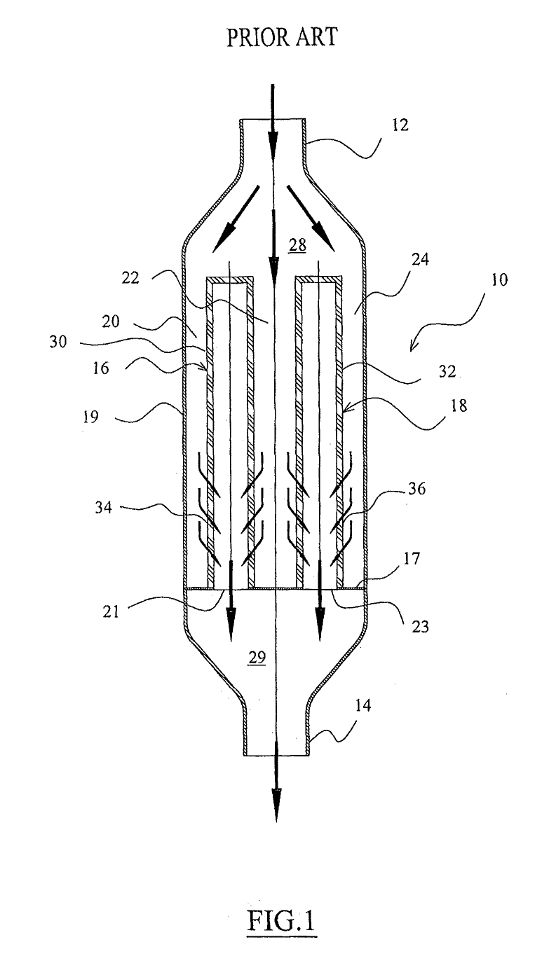

### BEST MODE FOR CARRYING OUT THE INVENTION

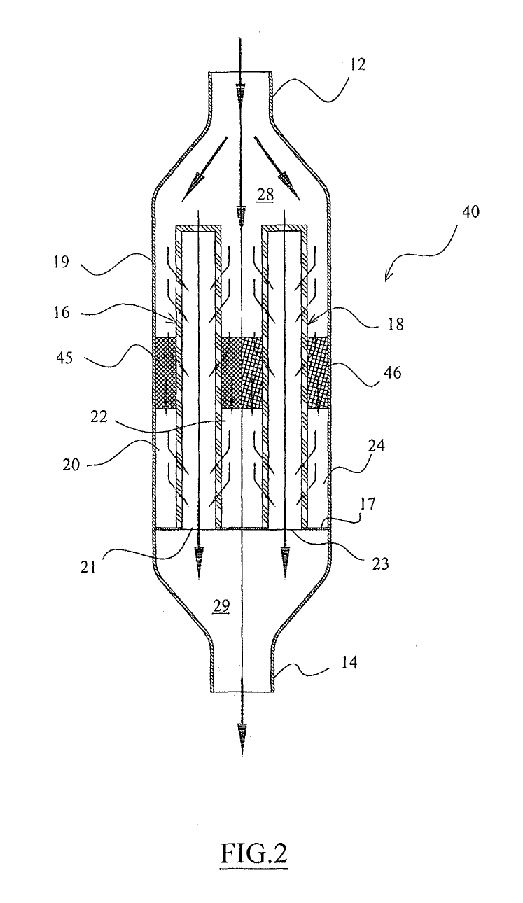

FIG. 2 illustrates an axial filter 40 for fluids, the filter 40 comprising a casing 19 having a substantially tubular shape, the casing 19 being provided with an inlet conduit 12 of the fluid to be filtered and an outlet conduit 14 for the filtered fluid.

A perforated plate (perforations at 21 and 23) is provided internally of the casing 19, on which plate tubular filter membranes 16, 18 are located, which filter membranes 16, 18 develop parallel to the axis of the casing 19 and divide the internal volume thereof into two chambers 28, 29, of which a first chamber 28 is in communication with the inlet conduit 12 for the fluid to be filtered and a second chamber 29 is in communication with the outlet conduit 14 for the filtered fluid.

The fluid to be filtered thus passes into the volumes 20, 22, 24 of the first chamber 28 which enable passage of the fluid through the filter membranes.

In a realisation of the present invention, the axial filter 40 comprises pressure distributors 45, 46 located internally of the chamber 28.

In more detail, a pressure distributor 45, 46 is located about each of the tubular filter membranes 16, 18, and intercepts the flow of the fluid to be filtered and is located in an intermediate position on the respective membrane in order to facilitate a homogeneous passage of the fluid across the whole filter membrane.

The pressure distributors 45, 46 are preferably semi-circular in shape such as to surround the respective filter membrane 16, 18 on a part of the external longitudinal surface thereof, and to be located in contact with both the other distributor and with the casing.

Each pressure distributor 45, 46 is preferably arranged perpendicular with respect to the longitudinal development of the casing and thus perpendicularly to the fluid flow.

Further, each of the distributors 45, 46 is preferably located in a defined intermediate portion with respect to the length of the filter, such as to completely close the fluid passage channel (FIG. 2).

With this arrangement, a greater pressure differential is maintained on the upstream parts of the filter elements 16, 18, which are otherwise poorly exploited.

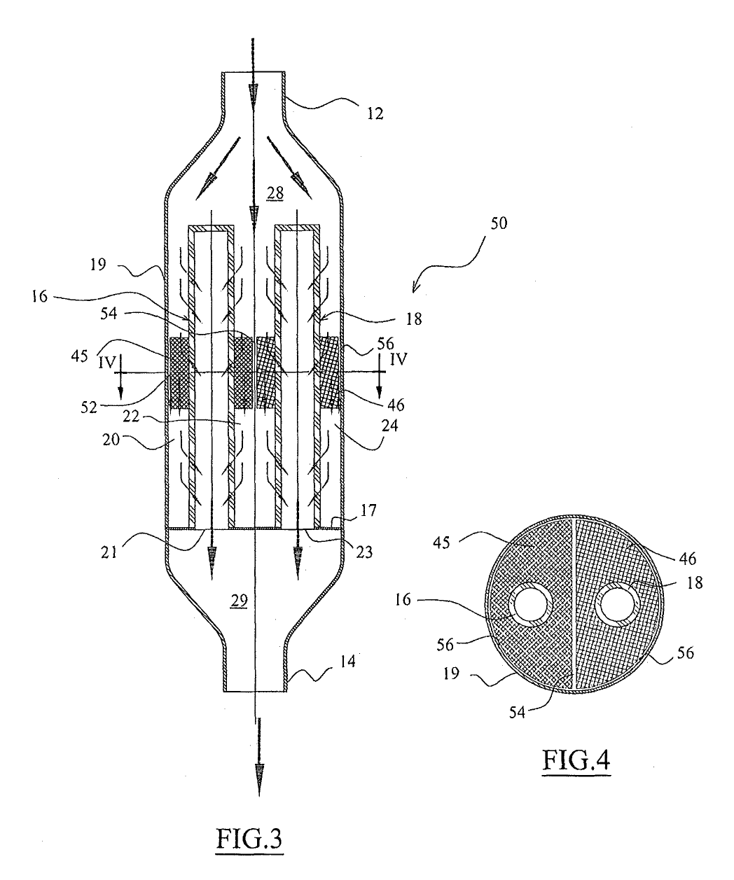

Alternatively (see FIG. 3) the pressure distributors 45, 46 can only partially close the volumes 20, 22, 24, leaving passages 52, 54, 56 for seepage of the fluid to be filtered.

This can be realised, for example, with an external surface of each pressure distributor 45, 46 being distanced from the internal surface of the casing 19. The pressure distributors 45, 46 are preferably constituted by porous elements 45, 46 having a permeability which is considerably greater than that of the filter membranes 16, 18. This does not however prevent passage there-through of a quantity of fluid to be filtered, such as to continue to exploit the filter surface of the membranes 16, 18 downstream of the distributors 45, 46.

In each case, the pressure distributors 45,46 being placed in intermediate position are in order to increase the pressure differential on the upstream parts of the filter elements 16, 18.

A widely-used measure of permeability in the sector is the Frazier permeability index, which is taken at the pressure differential of 0.5 inches of water, where the permeability is measured in terms of air flow in cubic feet per square foot of area of the sample.

With reference to an embodiment of the present invention, a possible Frazier permeability of the pressure distributors 45, 46 is 50 ft³/min*ft² per 0.5 inches of pressure differential water, with respect to a Frazier permeability of the filter membrane of 10 ft³/min*ft² per 0.5 inches of pressure differential water. The porosity of the pressure distributors 45, 46 can be selected such that the distributors 45, 46 can further also carry out a pre-filtering role, such that they are able to block the larger component present in the particle population.

If the axial filter includes one filter membrane only, the internal diameter of the pressure distributor is equal to the external diameter of the filter membrane to which it is applied, while the external diameter is equal to the internal diameter of the casing of the filter group.

Alternatively, the external diameter of the pressure distributor can be slightly smaller than the internal diameter of the tubular casing such as to leave an annular passage free for the fluid.

Obviously a technical expert in the sector might make numerous modifications of a practical-applicational nature to the invention, without its forsaking the ambit of the invention as claimed herein below.

In particular, in the case of tubular filter membranes of considerable axial dimensions, more than one pressure distributor might be included for each single filter membrane.

The pressure distributors on each membrane can advantageously be equidistant from one another.

1. A filter group (40) for fluids, comprising an external casing (19) having any section, suitable for receiving at least a filter membrane (16, 18) which develops parallel to the axis of the casing (19), for dividing an internal volume of the casing (19) into two chambers (28, 29), of which a first chamber (28) is in communication with an inlet conduit (12) for the fluid to be filtered and a second chamber (29) is in communication with an outlet conduit (14) of the filtered fluid, wherein at least a pressure distributor (45, 46) for each of the filter membranes is accommodated in the first chamber (28), which at least a pressure distributor element (45, 46) is suitable for axially separating a volume of the first chamber (28) into at least two parts, the pressure distributor element being made of a material that is permeable to the flow of fluid to be filtered, characterized in that the pressure distributor (45, 46) for each of the filter membranes is located in an intermediate position on the respective membrane and is configured to increase the pressure differential on the upstream parts of the filter elements (16, 18).

2. The filter group (40) of claim 1, characterised in that each pressure distributor element (45, 46) has a flat shape and comprises a hole which snugly receives the filter membrane (16, 18) and has an external profile which is complementary to an external profile of the other pressure distributor element and to an internal profile of the casing.

3. The filter group (40) of claim 2, characterised in that the external surface of the pressure distributor element (45, 46) is distanced from the internal surface of the tubular casing (19) such as to define passages (52, 54, 55) for the fluid.

4. The filter group (40) of claim 2, characterised in that the pressure distributor element (45, 46) is arranged perpendicularly with respect to the longitudinal development of the casing.

5. The filter group (40) of claim 1, characterised in that the pressure distributor element (45, 46) is constituted by a porous element having a greater permeability than the permeability of the filter membrane (16, 18).

6. The filter group (40) of claim 5, characterised in that the porosity of the pressure distributor element (45, 46) is selected such that the pressure distributor element (45, 46) is able to filter a larger component of particulate present in the fluid.

7. The filter group (40) of claim 1, characterised in that it comprises, internally of the tubular casing (19), a plurality of tubular filter membranes (16, 18), at least a pressure distributor element (45, 46) being associated to each of the plurality of tubular filter membranes (16, 18).
